(19) United States
(12) Patent Application Publication
(10) Pub. No.: US 2007/0095637 A1
(43) Pub. Date: May 3, 2007

(54) Appliance knob mounting system and method

(76) Inventors: Steve E. Hettinger, Louisville, KY (US); Mark A. Zaccone, Louisville, KY (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(21) Appl. No.: 11/263,559

(22) Filed: Oct. 31, 2005

(51) Int. Cl. H01H 13/00

(52) U.S. Cl. 200/296

(57) ABSTRACT

A control board assembly for controlling a home appliance includes a control board having at least one functional component, a control panel engaged with the control board, and a knob comprising a front side, a rear side, a first cylindrical portion extending from the rear side thereof which is coupled to said control panel, and a second cylindrical portion extending from the rear side thereof. The knob is configured to shield the control board from damage.

### BACKGROUND OF THE INVENTION

This invention relates generally to home appliances, and more particularly, to an appliance knob mounting system and method.

Washing machines typically include a cabinet that houses an outer tub for containing water, a perforated clothes basket within the tub, and an agitator within the basket. A drive and motor assembly is mounted underneath the stationary outer tub to rotate the clothes basket and the agitator relative to one another, and a pump assembly pumps water from the tub to a drain.

Known washing machines or dryers include a control board on which a plurality of control knobs is mounted, and a control chassis assembly is also used. This chassis assembly contains components which provide isolation of forces and limit or eliminate outside contamination. However, when a user imparts transverse and axial forces on the control knobs to operate the washing machine, the forces which transfer to the control board may damage the control board or its components. In addition, during the operation of the washing machine, some liquid may spill on the control board which contaminates the control board.

### BRIEF DESCRIPTION OF THE INVENTION

In one aspect, a control board assembly is provided for controlling a home appliance. The assembly includes a control board having at least one functional component, a control panel engaged with the control board, and a knob comprising a front side, a rear side, a first cylindrical portion extending from the rear side thereof which is coupled to said control panel, and a second cylindrical portion extending from the rear side thereof. The knob is configured to shield the control board from damage.

In another aspect, a home appliance is provided that includes a housing and a driving unit received in the housing. The driving unit is configured to provide power to home appliance. The appliance also includes a control unit assembly for controlling the driving unit. The control unit assembly includes a control board having at least one functional component, a control panel engaged with the control board, and a knob having a front side, a rear side, a first cylindrical portion extending from the rear side thereof which is coupled to the control panel, and a second cylindrical portion extending from the rear side thereof. The knob is configured to shield the control board from damage.

In still another aspect, a method is provided of assembling a control unit utilized in a home appliance for controlling operations thereof. The method including providing a control board with at least one functional component, coupling a rotary shaft to the control board, engaging a control panel with the control board, and providing a knob having a front side, a rear side, a first cylindrical portion extending from the rear side thereof which is coupled to the control panel, and a second cylindrical portion extending from the rear side thereof. The knob is configured to shield the control board from damage. The method further includes coupling the knob to the control panel with the receiving hole receiving an end of the rotary shaft. The knob is configured to shield the control panel from damage.

### BRIEF DESCRIPTION OF THE DRAWINGS

FIG. 1 is a perspective view partially broken away of an exemplary washing machine including a cabinet and a cover; and

FIG. 2 is a cross sectional view of the control board assembly shown in FIG. 1.

### DETAILED DESCRIPTION OF THE INVENTION

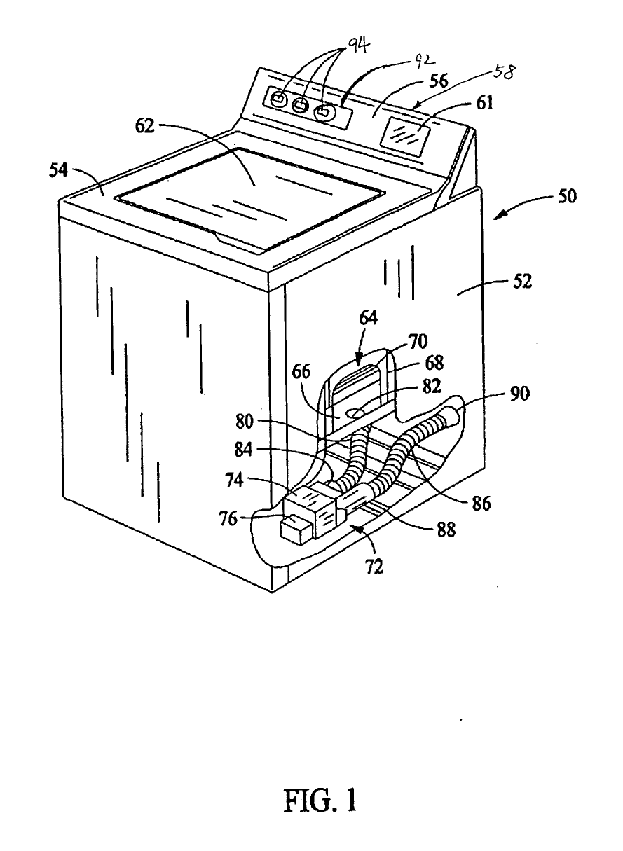

FIG. 1 is a perspective view partially broken away of an exemplary washing machine 50 including a cabinet 52 and a cover 54. A backsplash 56 extends from cover 54, and a control board assembly 58 is coupled to backsplash 56. A lid 62 is mounted to cover 54 and is movable between an open position (not shown) facilitating access to a wash tub 64 located within cabinet 52, and a closed position (shown in FIG. 1) forming a sealed enclosure over wash tub 64. As illustrated in FIG. 1, machine 50 is a vertical axis washing machine. However, the washing machine exemplified in FIG. 1 and described herein is only for illustration, and is not intended to be limiting in any aspect. Other types of clothes washers or dryers can also benefit from the spirit of the present invention.

Tub 64 includes a bottom wall 66 and a sidewall 68, and a basket 70 is rotatably mounted within wash tub 64. A pump assembly 72 is located beneath tub 64 and basket 70 for gravity assisted flow when draining tub 64. Pump assembly 72 includes a pump 74 and a motor 76. A pump inlet hose 80 extends from a wash tub outlet 82 in tub bottom wall 66 to a pump inlet 84, and a pump outlet hose 86 extends from a pump outlet 88 to an appliance washing machine water outlet 90 and ultimately to a building plumbing system discharge line (not shown) in flow communication with outlet 90.

Control board assembly 58 described below in detail could be utilized in connection with many different types of washing machines or washing dishers, and is not limited to practice in connection with any one particular clothes washer or dryer.

In the exemplary embodiment, control board assembly 58 includes a control panel 92 and a plurality of input selectors 94 which collectively form a user interface input for operator selection of machine cycles and features. In one embodiment, a display 61 indicates selected features, a countdown timer, and other items of interest to machine users.

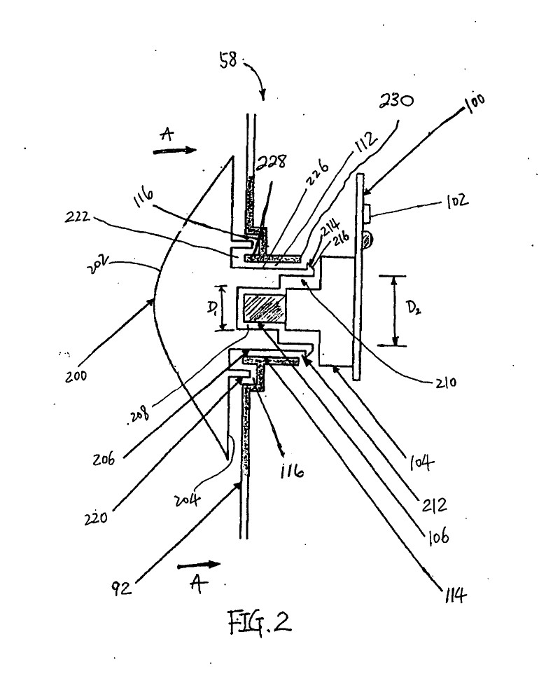

FIG. 2 is a cross sectional view of control board assembly 58 shown in FIG. 1. In the exemplary embodiment, control board assembly 58 includes a control board 100 which includes functional components 102 on one side. A rotary switch 104 is attached to the other side of control board 100 and a rotary shaft 106 extends from rotary switch 104. Control panel board 100 is engaged with control panel 92 by a known technique. Control panel 92 includes a central opening 112 therethrough defined by a central cylinder 114. Central opening 112 has a predetermined diameter, for example, 20 millimeters. Control panel 92 also defines a slot 116 adjacent central opening 112.

In the exemplary embodiment, control board assembly 58 includes a knob shell 200 designed to engage control panel 92. Knob shell 200 includes a front side having a curved surface 202, a rear side having a flat surface 204, and a first central cylindrical portion 206 extending from the rear side of knob shell 200. Central cylindrical portion 206 is a hollow cylinder. A first keyed receiving hole 208 and a second keyed receiving hole 210 are defined in the central portion of cylindrical portion 206 to receive rotary shaft 106 and at least a part of rotary switch 104. First receiving hole 208 has a diameter D1 which is smaller than a diameter D2 of second receiving hole 210. Each of receiving holes 208, 210 has a specific shape which is complementary to the shape of rotary shaft 106 and rotary switch 104, such as, cube shaped, triangle shaped, and D-shaped. At least one locking tab 212 extends from a peripheral end of central cylindrical portion 206. Each locking tab 212 includes a barb or fluke 214 with a slant surface 216 on the end. In one embodiment, a single locking tab extends around the peripheral end. In another embodiment, a plurality of tabs 212 extend around the peripheral end and are separated from adjacent tabs 212 by slots (not shown).

In the exemplary embodiment, a second cylinder 220 extends from the rear side of knob shell 200. Second cylinder 220 has a larger diameter than that of first central portion 206, and surrounds first central portion 206. A slot 222 is formed between an inner wall 224 of second cylinder 220 and an outside wall 226 of first central portion 206. In addition, a projecting portion 228 extends from central cylinder 114 and is configured to extend within slot 222.

During assembly, control board 100 is connected to control panel 92 as is known in the field. Once control panel 92 is engaged with control board 100, rotary switch 104 and rotary shaft 106 are received in central opening 112. Knob shell 200 engages control panel 92 such that first keyed receiving hole 208 aligns with rotary shaft 106. Knob shell 200 is moved in the direction indicated by arrows A so that at least one locking tab 212 extends into the space between the inner wall (not labeled) of first central cylindrical portion 206 and the outside surface (not labeled) of rotary shaft 106. During insertion of at least one locking tab 212 into the space, barbs 214 of locking tabs 212 are compressed until locking tabs 214 engage an end 230 of central cylinder 114. In addition, rotary shaft 106 is firmly received in second keyed receiving hole 210, and the wall of second cylinder 220 is received in slot 116. As such, knob shell 200 firmly engages control panel 92. In addition, cylinder 220, slot 116, and control cylinder 114 form a labyrinth seal between knob shell 200 and control panel 92. Thus, knob shell 200 mounts to control panel 92 and does not directly mount to rotary shaft 106. Rather, rotary shaft 106 extends into receiving hole 210 and rotates with rotation of knob shell 200 due to the keyed configuration of the end of rotary shaft 106 and receiving hole 210. When knob shell 200 is rotated by a user, rotary switch 104 is also rotated via rotary shaft 106, as first keyed receiving hole 208 has a specific shape complementary to the shape of rotary shaft 106.

Because the outer diameter of central cylindrical portion of the knob shell interacts with the inner diameter of the central cylinder of the control panel, any transverse or axial force exerted on the knob shell is transferred directly to the control panel. As a result, the control board and its components are protected from possible damage under the action of outside force. Due to the labyrinth seal formed between the knob shell and the control panel, the control board is also protected from contamination which could occur if some liquid is spilled by the user on the control panel. Moreover, it eliminates the traditional control chassis in known washing machines or dish washers.

While the invention has been described in terms of various specific embodiments, those skilled in the art will recognize that the invention can be practiced with modification within the spirit and scope of the claims.

We claim:

1. A control board assembly for controlling a home appliance, comprising:
a control board comprising at least one functional component;
a control panel engaged with said control board; and
a knob comprising a front side, a rear side, a first cylindrical portion extending from the rear side thereof which is coupled to said control panel, and a second cylindrical portion extending from the rear side thereof, said knob configured to shield said control board from damage.

2. The control board assembly in accordance with claim 1 wherein said second cylindrical portion extends into a slot formed on said control panel thereby forming a labyrinth seal.

3. The control board assembly in accordance with claim 2 wherein at least one locking tab extends from a peripheral end of said central cylinder to facilitate retaining said knob with said control panel.

4. The control board assembly in accordance with claim 1 wherein said cylindrical portion comprises a keyed receiving hole having a specific shape.

5. The control board assembly in accordance with claim 4 wherein said control board comprises a switch shaft which is configured to be received in said keyed receiving hole of said central cylinder and having a complementary shape.

6. The control board assembly in accordance with claim 4 wherein said knob comprises a slot defined by said cylinders, said control panel forming a projection configured to extend into said slot.

7. The control board assembly in accordance with claim 1 wherein said knob comprises a curved surface at the front side and a flat surface at the rear side thereof.

8. The control board assembly in accordance with claim 1 wherein said control panel comprises an opening for receiving said cylindrical portion of said protective member.

9. A home appliance, comprising:
a housing;
a driving unit received in said housing, said driving unit configured to provide power to home appliance; and
a control unit assembly for controlling said driving unit, said control unit assembly comprising:
a control board comprising at least one functional component;
a control panel engaged with said control board; and
a knob comprising a front side, a rear side, a first cylindrical portion extending from the rear side thereof which is coupled to said control panel, and a second cylindrical portion extending from the rear side thereof, said knob configured to shield said control board from damage.

10. The home appliance in accordance with claim 9 wherein said second cylindrical portion extends into a slot formed on said control panel thereby forming a labyrinth seal.

11. The home appliance in accordance with claim 10 wherein at least one locking tab extends from a peripheral end of said central cylinder to facilitate retaining said protective member with said control panel.

12. The home appliance in accordance with claim 9 wherein said cylindrical portion comprises a keyed receiving hole having a specific shape.

13. The home appliance in accordance with claim 12 wherein said control board comprises a switch shaft configured to be received in said keyed receiving hole of said central cylinder and having a complementary shape.

14. The home appliance in accordance with claim 9 wherein said knob comprises a slot defined by said cylinders, said control panel forming a projection configured to extend into said slot.

15. The home appliance in accordance with claim 9 wherein said knob comprises a curved surface at the front side and a flat surface at the rear side thereof.

16. The home appliance in accordance with claim 9 wherein said control panel comprises an opening for receiving said cylindrical portion of said protective member.

17. A method of assembling a control unit which is utilized in a home appliance for controlling operations thereof, said method comprising:
providing a control board with at least one functional component;
coupling a rotary shaft to the control board;
engaging a control panel with the control board;
providing a knob having a front side, a rear side, a first cylindrical portion extending from the rear side thereof which is coupled to said control panel, and a second cylindrical portion extending from the rear side thereof, said knob configured to shield said control board from damage; and
coupling the knob to the control panel with the receiving hole receiving an end of the rotary shaft, the knob configured to shield the control panel from damage.

18. The method of assembling a control unit in accordance with claim 17 wherein coupling the knob to the control panel further comprises defining a receiving hole in the control panel to receive the first cylindrical portion.

19. The method of assembling a control unit in accordance with claim 17 wherein the knob comprises a slot defined by the cylinders and the control panel includes a projection formed thereon, said method further comprising inserting the projection into the slot.

20. The method of assembling a control unit in accordance with claim 17 further comprising forming at least one locking tab extending from a peripheral end of the first cylindrical portion, the at least one locking tab configured to retain the knob member with the control panel.

21. The method of assembling a control unit in accordance with claim 17 wherein coupling a knob to the control panel comprises defining a keyed receiving hole in the first cylindrical portion.
